(19) United States
(12) Patent Application Publication
(10) Pub. No.: US 2026/0179493 A1
(43) Pub. Date: Jun. 25, 2026

(54) DRIVING ASSISTANCE DEVICE, DRIVING ASSISTANCE METHOD, AND NON-TRANSITORY COMPUTER-READABLE STORAGE MEDIUM

(71) Applicant: HONDA MOTOR CO., LTD., Tokyo (JP)

(72) Inventors: Kiri YOSHIDA, Saitama (JP); Kohei MATSUDA, Saitama (JP); Kenjiro TORII, Saitama (JP); Shigenobu SAIGUSA, Tokyo (JP); Aya YANO, Saitama (JP); Youngjun AN, Tokyo (JP)

(21) Appl. No.: 19/411,673

(22) Filed: Dec. 8, 2025

(30) Foreign Application Priority Data
Dec. 24, 2024 (JP) 2024-227758

(51) Int. Cl. G08G 1/16

(52) U.S. Cl. CPC G08G 1/167

(57) ABSTRACT

A driving assistance device for a vehicle includes: an external environment recognition device that recognizes a nearby vehicle present around the vehicle; an acoustic device provided in a cabin of the vehicle; and a control device that controls the acoustic device. The control device includes: a lane change prediction unit that predicts whether there is a possibility that the vehicle will change lanes; and a notification unit that controls the acoustic device to output a notification by sound when it is predicted that there is a possibility that the vehicle will change lanes and there is a nearby vehicle on a lane into which the vehicle is going to change lanes. The notification unit sets a risk level based on a positional relationship between the nearby vehicle and the vehicle and changes a mode of the notification by the acoustic device depending on the risk level.

### TECHNICAL FIELD

The present invention relates to a driving assistance device, a driving assistance method, and a control program (stored in a non-transitory computer-readable storage medium).

### BACKGROUND ART

In recent years, there has been an increase in efforts to provide sustainable transportation systems that take into account people in vulnerable situations among traffic participants. To realize this, research and development related to driving assistance technology and autonomous driving technology are conducted to further improve the safety and convenience of traffic.

JP2010-86077A discloses a vehicle system including external cameras for capturing images of the surroundings of the vehicle and a control device that detects, based on the images captured by the external camera, a nearby vehicle approaching an intersection from a different direction than the vehicle, and performs notification accordingly.

When there is a nearby vehicle, the distance between the vehicle and the nearby vehicle varies, and the risk level varies accordingly. Therefore, if strong notification that gives a sense of urgency is performed when the risk level is low, the driver may feel discomfort.

### SUMMARY OF THE INVENTION

In view of the foregoing background, an object of one aspect of the present invention is to provide a driving assistance device, a driving assistance method, and a control program that can provide appropriate notification to the driver when the vehicle is on the merging lane.

To achieve the above object, one aspect of the present invention provides a driving assistance device for a vehicle, the driving assistance device comprising: an external environment recognition device that recognizes a nearby vehicle present around the vehicle; an acoustic device provided in a cabin of the vehicle; and a control device that controls the acoustic device, wherein the control device comprises: a lane change prediction unit that predicts whether there is a possibility that the vehicle will change lanes; and a notification unit that controls the acoustic device to output a notification by sound when it is predicted that there is a possibility that the vehicle will change lanes and there is a nearby vehicle on a lane into which the vehicle is going to change lanes, and wherein the notification unit sets a risk level based on a positional relationship between the nearby vehicle present on the lane into which the vehicle is going to change lanes and the vehicle and changes a mode of the notification by the acoustic device depending on the risk level.

Another aspect of the present invention provides a driving assistance method for a vehicle, wherein the driving assistance method is to be executed by a computer and comprises: predicting whether there is a possibility that the vehicle will change lanes; controlling an acoustic device to output a notification by sound when it is predicted that there is a possibility that the vehicle will change lanes and there is a nearby vehicle on a lane into which the vehicle is going to change lanes; setting a risk level based on a positional relationship between the nearby vehicle present on the lane into which the vehicle is going to change lanes and the vehicle; and changing a mode of the notification by the acoustic device depending on the risk level.

Another aspect of the present invention provides a non-transitory computer-readable storage medium, comprising a stored control program, the control program configured to cause a computer to execute a driving assistance method for a vehicle, the driving assistance method comprising: predicting whether there is a possibility that the vehicle will change lanes; controlling an acoustic device to output a notification by sound when it is predicted that there is a possibility that the vehicle will change lanes and there is a nearby vehicle on a lane into which the vehicle is going to change lanes; setting a risk level based on a positional relationship between the nearby vehicle present on the lane into which the vehicle is going to change lanes and the vehicle; and changing a mode of the notification by the acoustic device depending on the risk level.

According to the above aspects of the present invention, a driving assistance device, a driving assistance method, and a control program that can provide appropriate notification to the driver when the vehicle is on the merging lane can be provided.

### BRIEF DESCRIPTION OF THE DRAWINGS

FIG. 1 is a configuration diagram of a driving assistance device according to an embodiment;

FIG. 2 is an explanatory diagram of a merging lane;

FIG. 3 is an explanatory diagram showing an example of a risk map set around the vehicle; and

FIG. 4 is a flowchart showing a procedure of driving assistance control executed by a control device.

### DETAILED DESCRIPTION OF THE INVENTION

In the following, embodiments of a driving assistance device, a driving assistance method, and a control program will be described with reference to the drawings.

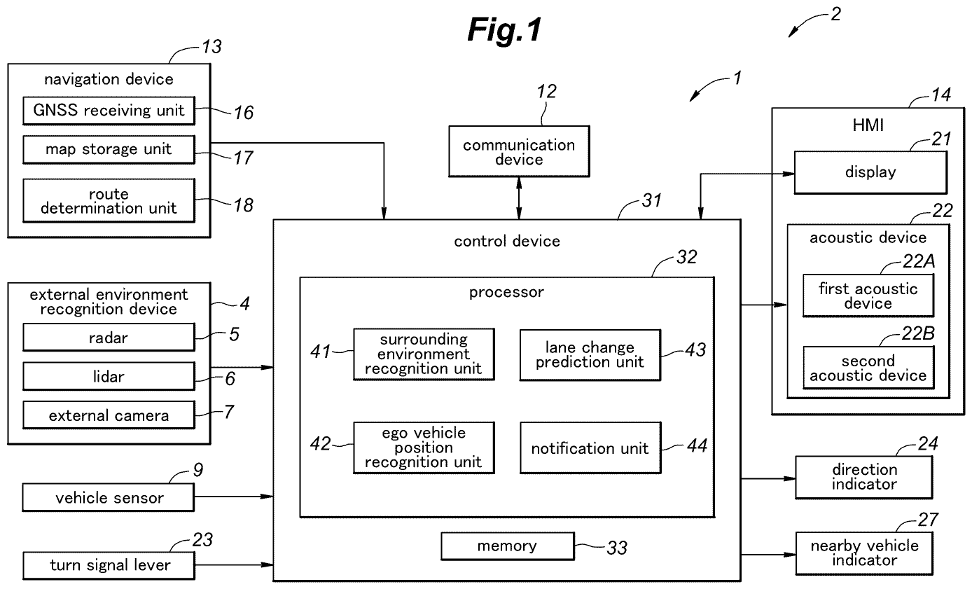

As shown in FIG. 1, a driving assistance device 1 is provided in a vehicle 2. The vehicle 2 may be a four-wheeled automobile, for example.

The driving assistance device 1 includes an external environment recognition device 4. The external environment recognition device 4 is a device that detects objects outside the vehicle 2. The external environment recognition device 4 is a sensor that detects objects or the like outside the vehicle 2 by capturing electromagnetic waves or light from the surroundings of the vehicle 2. The external environment recognition device 4 includes a radar 5, a lidar 6, and an external camera 7, for example.

The driving assistance device 1 includes a vehicle sensor 9. The vehicle sensor 9 includes a vehicle speed sensor that detects the speed of the vehicle 2 and an acceleration sensor that detects the acceleration of the vehicle 2. The vehicle sensor 9 may include a yaw rate sensor that detects an angular velocity around a vertical axis, a direction sensor that detects the direction of the vehicle 2, etc.

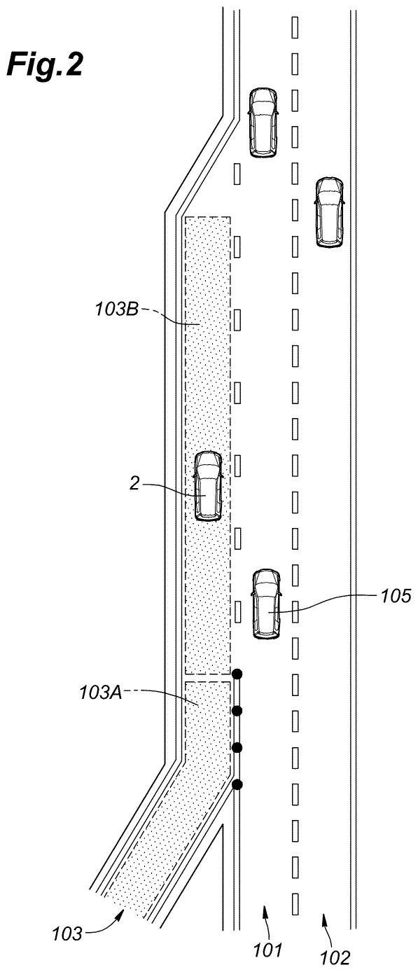

The driving assistance device 1 includes a communication device 12, a navigation device 13, and a human machine interface (HMI) 14. The communication device 12 mediates the communication of the driving assistance device 1 and the navigation device 13 with nearby vehicles 105 (see FIG. 2) and a server located outside the vehicle 2.

The navigation device 13 is a device that acquires the current position of the vehicle 2 and provides route guidance to the destination and other functions. The navigation device 13 preferably includes a global navigation satellite system (GNSS) receiving unit 16, a map storage unit 17, and a route determination unit 18. The GNSS receiving unit 16 identifies the position (latitude and longitude) of the vehicle 2 based on the signals received from artificial satellites (positioning satellites). The map storage unit 17 is composed of a known storage device such as a flash memory or a hard disk and stores map information.

The HMI 14 notifies the occupant of various kinds of information by display and/or voice and receives input operations performed by the occupant. The HMI 14 includes a display 21 and an acoustic device 22. The display 21 is preferably a touch panel display including a liquid crystal display, an organic EL display, or the like. The display 21 may function as a navigation interface through which input to/output from the navigation device 13 is performed.

The acoustic device 22 is provided in the cabin of the vehicle 2. The acoustic device 22 includes a first acoustic device 22A and a second acoustic device 22B having a shorter latency than the first acoustic device 22A. The first acoustic device 22A is preferably a speaker capable of outputting voice. The second acoustic device 22B is preferably a buzzer capable of outputting a sound effect. The second acoustic device 22B is preferably a piezoelectric buzzer or an electromagnetic buzzer, for example. The first acoustic device 22A can output sound over a wider frequency range than the second acoustic device 22B. The first acoustic device 22A can output higher quality sound than the second acoustic device 22B. The first acoustic device 22A is preferably driven based on a digital audio signal. The second acoustic device 22B is preferably driven by an ON/OFF signal. The second acoustic device 22B has a simpler structure than the first acoustic device 22A.

The driving assistance device 1 includes a turn signal lever 23. The turn signal lever 23 is an operation input device with which the driver operates a direction indicator 24. The direction indicator 24 is provided on a front portion or rear portion of the vehicle 2 and notifies the traveling direction of the vehicle 2 to the outside by emitting light.

The driving assistance device 1 includes a nearby vehicle indicator 27 for indicating the presence of nearby vehicles 105. The nearby vehicle indicator 27 turns on when there is a nearby vehicle 105 within a predetermined range around the vehicle 2 to make the driver aware of the presence of the nearby vehicle 105. The nearby vehicle indicator 27 is a so-called Blind Spot Information (BSI) system. The nearby vehicle indicator 27 is preferably provided on each side mirror of the vehicle 2, for example.

The driving assistance device 1 includes a control device 31 that controls the acoustic device 22. The control device 31 is a computer including a processor 32 and a memory 33 communicatively connected to the processor 32. The processor 32 preferably includes, as a core, at least one of a central processing unit (CPU), a graphics processing unit (GPU), and a reduced instruction set computer (RISC), for example. The memory 33 stores a control program executed by the processor 32 and various data. The memory 33 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the driving assistance device 1 may be realized by hardware such as a large scale integration (LSI) circuit, an application specific integrated circuit (ASIC), or a field-programmable gate array (FPGA) or may be realized by a combination of software and hardware. The driving assistance device 1 may be composed of one piece of hardware or may be composed of multiple pieces of hardware capable of communicating with each other. A part of the driving assistance device 1 may be configured by an external server provided outside the vehicle 2.

The processor 32 implements various applications by executing the control program stored in the memory 33. The control program may be stored in a removable recordable medium such as a DVD or a CD-ROM and may be installed into the memory 33 when the recordable medium is read by a reading device. Also, the control program may be downloaded via a communication network such as the internet and installed into the memory 33.

By executing the control program stored in the memory 33, the processor 32 functions as a surrounding environment recognition unit 41, an ego vehicle position recognition unit 42, a lane change prediction unit 43, and a notification unit 44.

The surrounding environment recognition unit 41 recognizes the surrounding environment of the vehicle 2. The surrounding environment recognition unit 41 recognizes, based on the detection result of the external environment recognition device 4, the surrounding environment (external environment) including obstacles present around the vehicle 2, road shape, lane markings, presence or absence of sidewalks, road markings, etc. The obstacles include guardrails, utility poles, nearby vehicles 105 (see FIG. 2), and persons such as pedestrians, for example. The surrounding environment recognition unit 41 can acquire a state, such as the position, velocity, and acceleration of each nearby vehicle 105 from the detection result of the external environment recognition device 4.

The ego vehicle position recognition unit 42 recognizes the position of the vehicle 2 (ego vehicle). The ego vehicle position recognition unit 42 preferably recognizes the position of the vehicle 2 based on the GNSS signal received by the GNSS receiving unit 16. Also, the ego vehicle position recognition unit 42 preferably recognizes the area in which the vehicle 2 is present based on the position of the vehicle 2 and the map information. For example, as shown in FIG. 2, the area preferably includes main lanes 101, 102 and a merging lane 103 that merges with the main lane 101. The merging lane 103 preferably includes a preparation section 103A and a mergeable section 103B. The mergeable section 103B extends in parallel with the main lane 101. The vehicle 2 can change lanes into the main lane 101 in the mergeable section 103B. The preparation section 103A is separated from the main lane 101 by a hard nose, such as walls, or a soft nose, such as traffic poles.

The lane change prediction unit 43 predicts whether there is a possibility that the vehicle 2 will change lanes. The lane change prediction unit 43 may predict whether there is a possibility that the vehicle 2 will change lanes based on the area in which the vehicle 2 is present. For example, the lane change prediction unit 43 may predict that there is a possibility that the vehicle 2 will change lanes when the vehicle 2 is in the mergeable section 103B. Also, the lane change prediction unit 43 may predict that there is a possibility that the vehicle 2 will change lanes based on the signal from the turn signal lever 23. Namely, the lane change prediction unit 43 may determine whether the turn signal lever 23 is operated based on the signal corresponding to rightward or leftward movement which is outputted from the turn signal lever 23 and may predict that there is a possibility that the vehicle 2 will change lanes when the turn signal lever 23 is operated. Also, the lane change prediction unit 43 may predict that there is a possibility that the vehicle 2 will change lanes when the vehicle 2 is in the mergeable section 103B and the turn signal lever 23 is operated.

The notification unit 44 performs notification by sound by controlling the acoustic device 22 when it is predicted that there is a possibility that the vehicle 2 will change lanes and there is a nearby vehicle 105 on the lane into which the vehicle 2 is going to change lanes. The notification unit 44 acquires information on whether there is a possibility that the vehicle 2 will change lanes from the lane change prediction unit 43.

The lane on which the vehicle 2 is traveling is referred to as the current lane, and the lane into which the vehicle 2 is going to change lanes is referred to as the target lane. The notification unit 44 preferably determines the target lane based on the surrounding environment of the vehicle 2 acquired by the surrounding environment recognition unit 41. For example, when it is determined that there is no lane to the left of the current lane based on the surrounding environment of the vehicle 2, the notification unit 44 preferably sets the lane to the right of the current lane as the target lane. When it is determined that there is no lane to the right of the current lane based on the surrounding environment of the vehicle 2, the notification unit 44 preferably sets the lane to the left of the current lane as the target lane. Also, when the vehicle 2 is in the mergeable section 103B, the notification unit 44 preferably sets the main lane 101 as the target lane.

The notification unit 44 may determine the target lane based on the signal from the turn signal lever 23. For example, when a signal corresponding to rightward movement is received from the turn signal lever 23, the notification unit 44 preferably sets the lane to the right of the current lane as the target lane. Also, when a signal corresponding to leftward movement is received from the turn signal lever 23, the notification unit 44 preferably sets the lane to the left of the current lane as the target lane.

The notification unit 44 sets a risk level based on the positional relationship between the nearby vehicle 105 present on the target lane and the vehicle 2 and changes the mode of the notification by the acoustic device 22 depending on the risk level. The notification unit 44 determines whether there is a nearby vehicle 105 on the target lane based on the surrounding environment of the vehicle 2 acquired by the surrounding environment recognition unit 41. The nearby vehicles 105 that are eligible are preferably those positioned within a predetermined range from the vehicle 2. Also, the nearby vehicles 105 that are eligible may be those whose time to collision (TTC) with the vehicle 2 is less than or equal to a predetermined value.

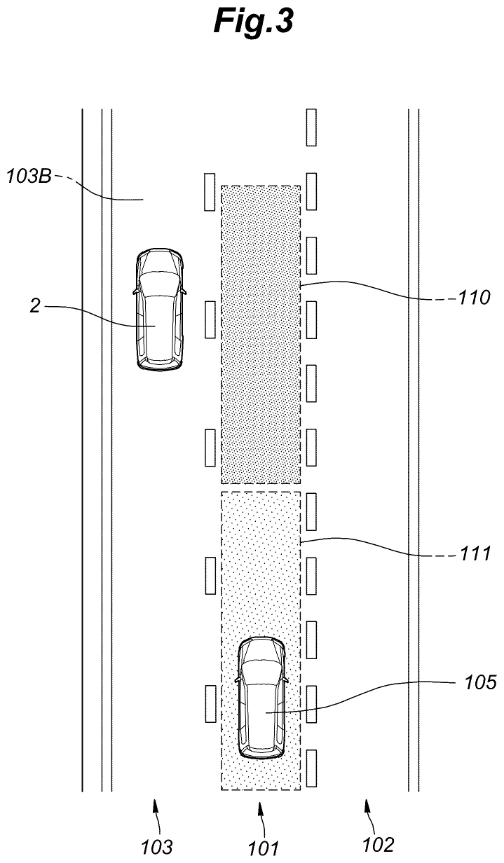

The notification unit 44 preferably sets the risk level based on the position of the nearby vehicle 105 present on the target lane. For example, the notification unit 44 may set the risk level based on the position of the nearby vehicle 105 with respect to the vehicle 2 by using a risk map in which the risk level for each position with respect to the position of the vehicle 2 is set. A higher value of the risk level represents a higher risk of collision. In the risk map, the closer the position is to the vehicle 2, namely, the smaller the distance to the vehicle 2 is, the higher the risk level becomes. The risk map may be preferably set as shown in FIG. 3, for example. In this example, in the target lane, the risk level for a first region 110 which corresponds to a lateral side of the vehicle 2 is set to 2, and the risk level of a second region 111 located to the rear of the first region 110 is set to 1.

The notification unit 44 controls at least one of the first acoustic device 22A and the second acoustic device 22B based on the risk level and causes the at least one of the first acoustic device 22A and the second acoustic device 22B to output a notification. The notification unit 44 preferably selects the acoustic device 22 that outputs the notification from the first acoustic device 22A and the second acoustic device 22B depending on the risk level. Preferably, the notification unit 44 causes the first acoustic device 22A and the second acoustic device 22B to output the notification when the risk level is higher than or equal to a predetermined determination value, and causes the first acoustic device 22A to output the notification when the risk level is lower than the determination value.

For example, when the risk level is higher than or equal to the determination value, the notification unit 44 causes the second acoustic device 22B, which is a buzzer, for example, to output a warning sound and causes the first acoustic device 22A, which is a speaker, for example, to output a notification by voice. The warning sound may be a beep or a buzzing sound generated by a buzzer, for example. The notification outputted from the first acoustic device 22A preferably includes the direction of the position of the nearby vehicle 105 with respect to the vehicle 2 and wording corresponding to the risk level. The direction of the position of the nearby vehicle 105 with respect to the vehicle 2 is preferably a voice such as “right,” “left,” “right rear,” or “left rear,” for example. The wording corresponding to the risk level may be “danger,” “caution,” etc. Preferably, when the risk level is high, “danger” is selected, and when the risk level is low, “caution” is selected. The notification preferably includes the direction of the position of the nearby vehicle 105 with respect to the vehicle 2 in the beginning part thereof, and includes the wording corresponding to the risk level after that. Thus, the notification outputted from the first acoustic device 22A may be a voice such as “right, danger.”

In the case where the notification unit 44 controls the first acoustic device 22A and the second acoustic device 22B simultaneously, the warning sound outputted from the second acoustic device 22B is outputted earlier than the voice outputted from the first acoustic device 22A because the latency of the second acoustic device 22B is shorter than that of the first acoustic device 22A. Namely, the second acoustic device 22B can provide notification to the driver more promptly than the first acoustic device 22A.

The notification unit 44 causes the first acoustic device 22A, which is a speaker for example, to output a voice such as “right, caution” when the risk level is lower than the determination value, for example. In this case, it is preferable that the notification unit 44 does not cause the second acoustic device 22B to output a notification.

The notification unit 44 may change the mode of the notification by the acoustic device 22 depending on the risk level and the state of the direction indicator 24. When the direction indicator 24 is not activated, the notification unit 44 may raise the level of the notification mode than when the direction indicator 24 is activated. Also, when the direction indicator 24 is not activated, the notification unit 44 may perform notification by speech such as “operate the turn signal lever” or “prepare for lane change.” Also, the notification unit 44 may change the notification mode based on the state of the turn signal lever 23 instead of the state of the direction indicator 24.

The notification unit 44 turns on the nearby vehicle indicator 27 when there is a nearby vehicle 105 within a predetermined range around the vehicle 2. The notification unit 44 may change the lighting mode of the nearby vehicle indicator 27 based on the operation state of the turn signal lever 23. The notification unit 44 may cause the nearby vehicle indicator 27 to blink, namely, to turn on and off intermittently when there is a nearby vehicle 105 within the predetermined range around the vehicle 2 and the turn signal lever 23 is operated. Also, the notification unit 44 may continuously turn on the nearby vehicle indicator 27 when there is a nearby vehicle 105 within the predetermined range around the vehicle 2 and the turn signal lever 23 is not operated.

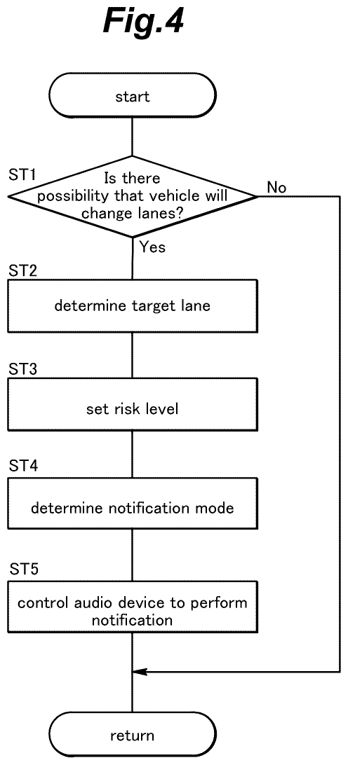

The control device 31 preferably performs driving assistance control according to the control procedure of the driving assistance control shown in FIG. 4. The control device 31 first predicts whether there is a possibility that the vehicle 2 will change lanes (ST1). The determination in ST1 is preferably performed by the lane change prediction unit 43 as described above. When there is no possibility that the vehicle 2 will change lanes (ST1: No), the process proceeds to “return” and the driving assistance control is repeated from ST1.

When there is a possibility that the vehicle 2 will change lanes (ST1: Yes), the control device 31 determines the lane into which the lane change is to be made, namely, the target lane (ST2).

Subsequently, the control device 31 sets a risk level. As described above, the control device 31 preferably sets the risk level based on the positional relationship between the vehicle 2 and the nearby vehicle 105 present on the target lane (ST3).

Then, the control device 31 determines the notification mode of the acoustic device 22 according to the risk level (ST4). Next, the control device 31 controls the acoustic device 22 according to the notification mode to cause the acoustic device 22 to output a notification by sound (ST5).

According to the embodiment, the driving assistance device 1 can provide appropriate notification to the driver when the vehicle 2 is on the merging lane 103. Since the notification mode of the acoustic device 22 is changed depending on the risk level, it is possible to prevent the notification from causing annoyance, discomfort, a sense of excessive tension, etc. to the driver. When the risk level is high, the second acoustic device 22B having a shorter latency than the first acoustic device 22A outputs a warning sound, and thus, the driver can sense danger promptly.

The control device 31 performs notification in response to the nearby vehicle 105 on the target lane only when there is a possibility that the vehicle 2 will change lanes. Namely, when the vehicle 2 is moving forward on the main lane 101, the control device 31 does not perform notification even if the nearby vehicle 105 on the adjacent main lane 102 approaches the vehicle 2.

The embodiment may be modified in various ways without being limited to the above-described configuration. For example, though in the embodiment, the control device 31 sets the risk level based on the positional relationship between the vehicle 2 and the nearby vehicle 105, the control device 31 may set the risk level based on the time to collision between the vehicle 2 and the nearby vehicle 105. In this case, the time to collision may be calculated based on the position and the component of the velocity of each of the vehicle 2 and the nearby vehicle 105 in the direction along the main lane 101.

The above embodiment may be described as follows.

One embodiment is a driving assistance device 1 for the vehicle 2, the driving assistance device 1 comprising: an external environment recognition device 4 that recognizes a nearby vehicle 105 present around the vehicle 2; an acoustic device 22 provided in a cabin of the vehicle 2; and a control device 31 that controls the acoustic device 22, wherein the control device 31 comprises: a lane change prediction unit 43 that predicts whether there is a possibility that the vehicle 2 will change lanes; and a notification unit 44 that controls the acoustic device 22 to output a notification by sound when it is predicted that there is a possibility that the vehicle 2 will change lanes and there is a nearby vehicle 105 on a lane into which the vehicle 2 is going to change lanes, and wherein the notification unit 44 sets a risk level based on a positional relationship between the nearby vehicle 105 present on the lane into which the vehicle 2 is going to change lanes and the vehicle 2 and changes a mode of the notification by the acoustic device 22 depending on the risk level.

According to this aspect, a driving assistance device 1 that can provide appropriate notification to the driver when the vehicle 2 is on the merging lane 103 can be provided. Since the notification mode is changed depending on the risk level, it is possible to prevent the notification from causing annoyance, discomfort, a sense of excessive tension, etc. to the driver.

In the above embodiment, the acoustic device 22 may include a first acoustic device 22A and a second acoustic device 22B having a shorter latency than the first acoustic device 22A, and the notification unit 44 may select the acoustic device 22 that outputs the notification from the first acoustic device 22A and the second acoustic device 22B depending on the risk level.

According to this aspect, it is possible to select an appropriate acoustic device 22 depending on the risk level.

In the above embodiment, the notification unit 44 may cause the first acoustic device 22A and the second acoustic device 22B to output the notification when the risk level is higher than or equal to a predetermined determination value, and may cause the first acoustic device 22A to output the notification when the risk level is lower than the determination value.

According to this aspect, when the risk level is high, the second acoustic device 22B having a shorter latency than the first acoustic device 22A is used, whereby notification is promptly made to the driver.

In the above embodiment, the first acoustic device 22A may be a speaker capable of outputting voice, and the second acoustic device 22B may be a buzzer capable of outputting a sound effect.

According to this aspect, the second acoustic device 22B with low latency can be realized.

In the above embodiment, the driving assistance device 1 may further comprise a direction indicator 24 that notifies a moving direction of the vehicle 2, wherein the notification unit 44 may change the mode of the notification by the acoustic device 22 depending on the risk level and a state of the direction indicator 24.

According to this aspect, the notification mode is changed depending on the state of the direction indicator 24.

In the above embodiment, the notification may include a direction of a position of the nearby vehicle 105 with respect to the vehicle 2 and wording corresponding to the risk level.

According to this aspect, the driver can recognize the direction in which the nearby vehicle 105 is present and the risk level from the notification.

Another embodiment is a driving assistance method for a vehicle 2, wherein the driving assistance method is to be executed by a computer and comprises: predicting whether there is a possibility that the vehicle 2 will change lanes; controlling an acoustic device 22 to output a notification by sound when it is predicted that there is a possibility that the vehicle 2 will change lanes and there is a nearby vehicle 105 on a lane into which the vehicle 2 is going to change lanes; setting a risk level based on a positional relationship between the nearby vehicle 105 present on the lane into which the vehicle 2 is going to change lanes and the vehicle 2; changing a mode of the notification by the acoustic device 22 depending on the risk level.

According to this aspect, a driving assistance method that can provide appropriate notification to the driver when the vehicle 2 is on the merging lane 103 can be provided.

Another embodiment is a non-transitory computer-readable storage medium, comprising a stored control program, the control program configured to cause a computer to execute a driving assistance method for a vehicle 2, the driving assistance method comprising: predicting whether there is a possibility that the vehicle 2 will change lanes; controlling an acoustic device 22 to output a notification by sound when it is predicted that there is a possibility that the vehicle 2 will change lanes and there is a nearby vehicle 105 on a lane into which the vehicle 2 is going to change lanes; setting a risk level based on a positional relationship between the nearby vehicle 105 present on the lane into which the vehicle 2 is going to change lanes and the vehicle 2; and changing a mode of the notification by the acoustic device 22 depending on the risk level.

According to this aspect, a control program for causing a computer to execute a driving assistance method that can provide appropriate notification to the driver when the vehicle 2 is on the merging lane 103 can be provided.

1. A driving assistance device for a vehicle, the driving assistance device comprising:
an external environment recognition device that recognizes a nearby vehicle present around the vehicle;
an acoustic device provided in a cabin of the vehicle; and
a control device that controls the acoustic device,
wherein the control device comprises:
a lane change prediction unit that predicts whether there is a possibility that the vehicle will change lanes; and
a notification unit that controls the acoustic device to output a notification by sound when it is predicted that there is a possibility that the vehicle will change lanes and there is a nearby vehicle on a lane into which the vehicle is going to change lanes,
and wherein the notification unit sets a risk level based on a positional relationship between the nearby vehicle present on the lane into which the vehicle is going to change lanes and the vehicle and changes a mode of the notification by the acoustic device depending on the risk level.

2. The driving assistance device according to claim 1, wherein the acoustic device includes a first acoustic device and a second acoustic device having a shorter latency than the first acoustic device, and
the notification unit selects the acoustic device that outputs the notification from the first acoustic device and the second acoustic device depending on the risk level.

3. The driving assistance device according to claim 2, wherein the notification unit causes the first acoustic device and the second acoustic device to output the notification when the risk level is higher than or equal to a predetermined determination value, and causes the first acoustic device to output the notification when the risk level is lower than the predetermined determination value.

4. The driving assistance device according to claim 2, wherein the first acoustic device is a speaker capable of outputting voice, and the second acoustic device is a buzzer capable of outputting a sound effect.

5. The driving assistance device according to claim 1, further comprising a direction indicator that notifies a moving direction of the vehicle,
wherein the notification unit changes the mode of the notification by the acoustic device depending on the risk level and a state of the direction indicator.

6. The driving assistance device according to claim 1, wherein the notification includes a direction of a position of the nearby vehicle with respect to the vehicle and wording corresponding to the risk level.

7. A driving assistance method for a vehicle, wherein the driving assistance method is to be executed by a computer and comprises:
predicting whether there is a possibility that the vehicle will change lanes;
controlling an acoustic device to output a notification by sound when it is predicted that there is a possibility that the vehicle will change lanes and there is a nearby vehicle on a lane into which the vehicle is going to change lanes;
setting a risk level based on a positional relationship between the nearby vehicle present on the lane into which the vehicle is going to change lanes and the vehicle; and
changing a mode of the notification by the acoustic device depending on the risk level.

8. A non-transitory computer-readable storage medium, comprising a stored control program, the control program configured to cause a computer to execute a driving assistance method for a vehicle, the driving assistance method comprising:
predicting whether there is a possibility that the vehicle will change lanes;
controlling an acoustic device to output a notification by sound when it is predicted that there is a possibility that the vehicle will change lanes and there is a nearby vehicle on a lane into which the vehicle is going to change lanes;
setting a risk level based on a positional relationship between the nearby vehicle present on the lane into which the vehicle is going to change lanes and the vehicle; and
changing a mode of the notification by the acoustic device depending on the risk level.
